(19) United States
(12) Patent Application Publication
(10) Pub. No.: US 2011/0183301 A1
(43) Pub. Date: Jul. 28, 2011

(54) METHOD AND SYSTEM FOR SINGLE-PASS RENDERING FOR OFF-AXIS VIEW

(75) Inventor: James A. Turner, Binghamton, NY (US)

(73) Assignee: L-3 COMMUNICATIONS CORPORATION, New York, NY (US)

(21) Appl. No.: 12/694,774

(22) Filed: Jan. 27, 2010

(51) Int. Cl. G09B 9/08

(52) U.S. Cl. 434/43

(57) ABSTRACT

A system and method are provided for review of a trainee being trained in simulation. The system has a computerized simulator displaying to the trainee a real-time out-the-window (OTW) scene of video made up of a series of images each rendered in real-time from stored scene data. A review system stores or displays a view of the OTW scene video as seen from a time-variable detected viewpoint of the trainee. Each frame of this video is independently rendered in a single pass from the scene data using a projection matrix that is derived from a detected eyepoint and line of sight of the trainee. A HUD display with imagery superimposed on the OTW view may advantageously combined with the perspective-distorted imagery of the review system. The video displayed or stored by the review system accurately records or displays the OTW scene as seen by the trainee.

### FIELD OF THE INVENTION

The present invention relates to simulators and simulation-based training, especially to flight simulators in which a student trains with a head-up display or helmet mounted sight with a flight instructor viewing an image depicting the simulation from the pilot's point of view in a separate monitor.

### BACKGROUND OF THE INVENTION

Flight training is often conducted in an aircraft simulator with a dummy cockpit with replicated aircraft controls, a replicated windshield, and an out-the-window (“OTW”) scene display. This OTW display is often in the form of an arrangement of screens on which OTW scene video is displayed by a projector controlled by an image generation computer. Each frame of the OTW scene video is formulated using a computerized model of the aircraft operation and a model of the simulated environment so that the aircraft in simulation performs similarly to the real aircraft being simulated, responsive to the pilot's manipulation of the aircraft controls, and as influenced by other objects in the simulated virtual world.

Simulators also can provide training in use of a helmet mounted display (HMD) in the aircraft. The HMD in present-day aircraft and in their simulators usually is a transparent visor mounted on the helmet worn by the pilot or a beamsplitter mounted on the cockpit. In either case, the HMD system displays images that are usually symbology (like character data about a target in sight) so that the symbology or other imagery is seen by the pilot as superimposed over the real object outside the cockpit or, in the simulator, the object to which it relates in the OTW scene. A head-tracking system, e.g., an ultrasound generator and microphones or magnetic transmitter and receiver, monitors the position and orientation of the pilot's head in the cockpit, and the HMD image generator produces imagery such that the symbology is in alignment with the object to which it relates, irrespective of the position or direction from which the pilot is looking.

In simulators with a HMD, it is often desirable that a flight instructor be able to simultaneously view the scene as observed by the pilot at a separate monitor in order to gauge the pilot's response to various events in the simulation. This instructor display is usually provided by a computerized instructor station that has a monitor that displays the OTW scene in the pilot's immediate field of view, including the HMD imagery, as real-time video.

A problem is encountered in preparing the composite image of the HMD and OTW scene imagery as seen by the pilot to the instructor, and this is illustrated in FIGS. 6 and 7. As seen in FIG. 7, the OTW scene imagery is video, each frame of which is a generated view of the virtual world from design eyepoint 113, usually the three-dimensional centerpoint of the cockpit, where the pilot's head is positioned when he or she sits up and looks straight forward.

The OTW scene includes images of objects, such as exemplary virtual aircraft 109 and 110, positioned appropriately for the view from the design eyepoint 113, usually with the screen 103 normal to the line of sight from the design eyepoint. When the pilot views the OTW scene imagery video 101 projected on a screen 103 from an actual viewpoint 115 that is not the design eyepoint 113, the pilot's view is oriented at a different non-normal angle to the screen 103, and objects 109 and 110 are seen located on the screen 103 at points 117 and 118, which do not align with their locations in the virtual world of the simulator scene data.

Expressed somewhat differently, as best seen in FIG. 6, due to the different angle of viewing of the screen 103 from the pilot eyepoint 115, the pilot sees the projected OTW scene 101 on screen 103 with a parallax or perspective distortion. At the same time, the HMD imagery 105 is created based on the head position of the pilot so that the symbology 107 and 108 properly aligns with the associated targets or objects 109 and 110 in the OTW view as seen by the pilot, including the perspective distortion, i.e., the symbology overlies points 117 and 118.

The instructor's view cannot be created by simply overlaying the HMD image 105 over the OTW imagery 101 because one image (the HMD) includes the pilot's perspective view, and the other (the OTW scene) does not. As a consequence, the instructor's view would not accurately reflect what the OTW scene looks like to the pilot, and also the symbology 107 and 108 and the objects 109 and 110 would not align with each other.

To provide an instructor with the trainee pilot's view, it is possible to create an image of what the pilot sees by mounting a camera on the helmet of the pilot to record or transmit video of what the pilot sees as the pilot undergoes simulation training. However, such a camera-based system would have many drawbacks, including that it produces only a lower-quality image, certainly of lower resolution than that of the image actually seen by the pilot. In addition, the mounted camera cannot be easily collocated with the pilot's eye position, but rather must be several inches above the pilot's eye on the helmet, and this offset results in an inaccurate depiction of the pilot's view.

Alternatively, a video displayed to the instructor on the instructor monitor can be generated using a multiple-pass rendering method. In such a method, a first image generator rendering pass creates an image or images in an associated frame buffer that replicates the portion of the OTW of interest as displayed on the screen 103 and constitutes the simulated OTW scene rendered from the design eyepoint 113. A second image generator rendering pass then accesses a 3D model of the display screen 103 of the simulator itself, and renders the instructor view as a rendered artificial view of the simulator display screen from the pilot's actual eye location 115, with the frame buffer OTW imagery applied as a graphical texture to the surfaces of the 3D model of the simulator display screens.

Such a system, however, also results in a loss in resolution in the final rendering of the simulation scene as compared to the resolution of the actual view from the pilot's line of sight due to losses in the second rendering. To offset this, it would be necessary to increase the resolution of the first “pass” or rendering of the OTW image displayed to the pilot, which would involve a first rendering of at least twice the pixel resolution as viewed by the second rendering at its furthest off-axis viewpoint in order to maintain a reasonable level of resolution in the final rendering of the recreated image of the simulation scene as viewed from the pilot's perspective. Rendering at such high pixel resolution would be a substantial drain on image generator performance, and therefore it is not reasonably possible to provide an instructor display of acceptable resolution as compared to the actual pilot view.

### SUMMARY OF THE INVENTION

It is therefore an object of the present invention to provide a system and method for displaying an image of the simulated OTW scene as it is viewed from the eyepoint of the pilot in simulation, that overcomes the problems of the prior art.

According to an aspect of the present invention, a system provides review of a trainee being trained in simulation. The system comprises a computerized simulator displaying to the trainee a real-time OTW scene of a virtual world rendered from scene data stored in a computer-accessible memory defining that virtual world. A review system having a storage device storing or a display device displays a view of the OTW scene from a time-variable detected viewpoint of the pilot. The view of the OTW scene is rendered from the scene data in a single rendering pass.

According to another aspect of the present invention, a system for providing simulation of a vehicle to a user comprises a simulated cockpit configured to receive the user and to interact with the user so as to simulate the vehicle according to simulation software running on a simulator computer system. A computer-accessible data storage memory device stores scene data defining a virtual simulation environment for the simulation, the scene data being modified by the simulation software so as to reflect the simulation of the vehicle. The scene data includes object data defining positions and appearance of virtual objects in a three-dimensional virtual simulation environment. The object data includes for each of the virtual objects a respective set of coordinates corresponding to a location of the virtual object in the virtual simulation environment. An OTW image generating system cyclically renders a series of OTW view frames of an OTW video from the scene data, each OTW view frame corresponding to a respective view at a respective instant in time of virtual objects in the virtual simulation environment from a design eyepoint located in the virtual simulation environment and corresponding to a predetermined point in the simulated vehicle as the point is defined in the virtual simulation environment. A video display device has at least one screen visible to the user when in the simulated cockpit, and the OTW video is displayed on the screen so as to be viewed by the user, A viewpoint tracker detects a current position and orientation of the user's viewpoint and transmits a viewpoint tracking signal containing position data and orientation data derived from the detected current position and current orientation. The system further comprises a helmet mounted display device viewed by the user such that the user can thereby see frames of HMD imagery. The HMD imagery includes visible information superimposed over corresponding virtual objects in the OTW view video irrespective of movement of the eye of the user in the simulated cockpit. A review station image generating system generates frames of review station video in a single rendering pass from the scene data. The frames each correspond to a rendered view of virtual objects of the virtual simulation environment as seen on the display device from a rendering viewpoint derived from the position data at a respective time instant in a respective rendering duty cycle combined with the HMD imagery. The rendering of the frames of the review station video comprises determining a location of at least some of the virtual objects of the scene data in the frame from vectors derived by calculating a multiplication of coordinates of each of the some of the virtual objects by a perspective-distorted projection matrix derived in the associated rendering duty cycle from the position and orientation data of the viewpoint tracking signal. A computerized instructor station system with a review display device receives the review station video and displays the review station video in real time on the review display device so as to be viewed by an instructor.

According to another aspect of the present invention, a method for providing instructor review of a trainee in a simulator comprises the steps of rendering sequential frames of an OTW view video in real time from stored simulator scene data, and displaying said OTW video to the trainee on a screen. A current position and orientation of a viewpoint of the trainee is continually detected. Sequential frames of a review video are rendered, each corresponding to a view of the trainee of the OTW view video as seen on the screen from the detected eyepoint. The rendering is performed in a single rendering pass from the stored simulator scene data.

According to still another aspect of the present invention, a method of providing a simulation of an aircraft for a user in a simulated cockpit with supervision or analysis by an instructor at an instruction station with a monitor comprises formulating scene data stored in a computer-accessible memory device than defines positions and appearances of virtual objects in a 3-D virtual environment in which the simulation takes place. An out-the-window view video is generated, the video comprising a first sequence of frames each rendered in real time from the scene data as a respective view for a respective instant in time from a design eyepoint in the aircraft being simulated as the design eyepoint is defined in a coordinate system in the virtual environment. The out-the-window view video is displayed on a screen of a video display device associated with the simulated cockpit so as to be viewed by the user. A time-varying position and orientation of a head or eye of the user is repeatedly detected using a tracking device in the simulated cockpit and viewpoint data defining the position and orientation is produced.

In real time an instructor-view video is generated, and it comprises a second sequence of frames each rendered in a single pass from the scene data based on the viewpoint data. Each frame corresponds to a respective view of the out-the-window video at a respective instant in time as seen from a viewpoint as defined by the viewpoint data on the screen of the video display device. The instructor-view video is displayed to the instructor on the monitor.

It is further an object of the invention to provide a system and method for rendering a simulated scene and displaying the scene for viewing by an individual training with a helmet mounted sight in a flight simulation, and rendering and displaying another image of the simulated scene as viewed from the perspective of the individual in simulation in a single rendering pass, such that symbology or information from a helmet sight is overlaid upon the recreated scene and displayed to an instructor.

Other objects and advantages of the invention will become apparent from the specification herein and the scope of the invention will be set out in the claims.

### BRIEF DESCRIPTION OF THE DRAWINGS

FIG. 1 is a schematic diagram of a system according to the present invention.

FIG. 2 is a schematic diagram of the system of FIG. 1 showing the components in greater detail.

FIG. 3 is a diagram illustrating the systems of axes involved in the transformation of the projection matrix for rendering the OTW scene image for video displayed on the OTW screen of the simulator.

FIG. 4 is a diagram illustrating the systems of axes involved in the additional transformation from the OTW view of the design eyepoint to the view as seen from the actual trainee eyepoint for rendering the instructor station video by the one-pass rendering method of the present invention.

FIG. 5 is a diagram illustrating the vectors used to derive the perspective-distorted projection matrix used in the system of the invention in one embodiment.

FIG. 6 is a diagram illustrating the relationship of a simulated HMD imagery to the displayed OTW imagery in a simulation.

FIG. 7 is a diagram illustrating in a two dimensional view the perspective problems associated with the projection image of an OTW scene and its display to an instructor terminal.

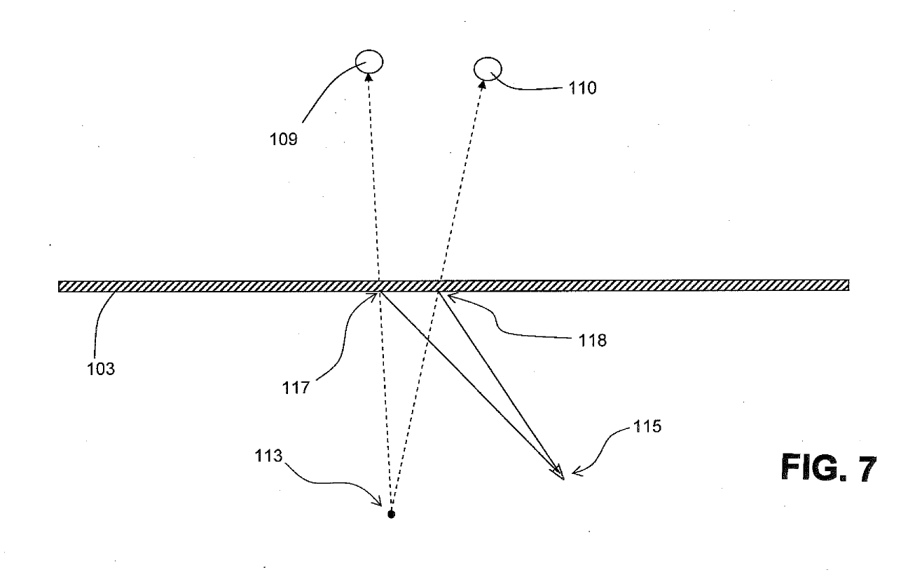

FIG. 8 is a diagram illustrating the perspective issues together with some of the geometry used in one of the embodiments of the present invention.

FIG. 9 is a diagram of the process of an OpenGL pipeline with its various transformations.

### DETAILED DESCRIPTION

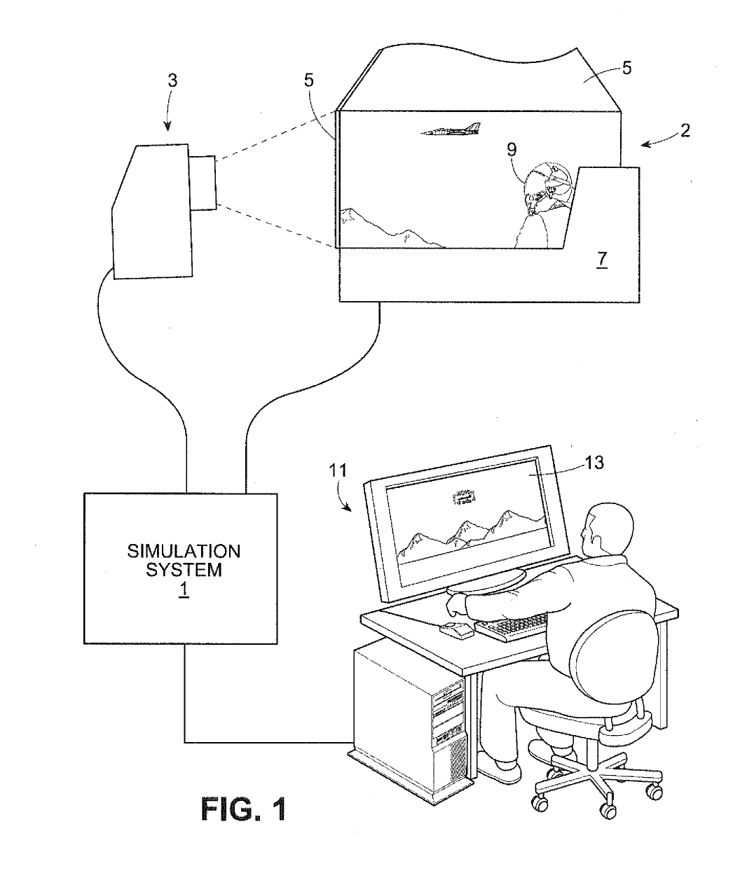

Referring to FIG. 1, simulation computer system 1 is a single computer system or a computer system with a distributed architecture. It runs the simulation according to stored computer-accessible software and data that makes the simulation emulate the real vehicle or aircraft being simulated, with the simulated vehicle operating in a virtual environment defined by scene data that is stored so as to be accessed by the simulation computer system 1.

Simulated cockpit 7 emulates the cockpit of the real vehicle being simulated, which in the preferred embodiment is an aircraft, but may be any type of vehicle. Cockpit 7 has simulated cockpit controls in the cockpit 7, such as throttle, stick and other controls mimicking those of the real aircraft, and is connected with and transmits electronic signals to simulation computer system 1 so the trainee can control the movement of the vehicle from the dummy cockpit 7.

The simulator 2 also includes a head-tracking or eye-tracking device that detects the instantaneous position of the head or eye(s) of the trainee. The tracking device senses enough position data to determine the present location of the head or eye and its orientation, i.e., any tilt or rotation of the trainee's head, such that the position of the trainee's eye or eyes and their line of sight can be determined. A variety of these tracking systems are well-known in the art, but in the preferred embodiment the head or eye tracking system is an ultrasound sensor system carried on the helmet of the trainee. The tracking system transmits electronic data signals derived from or incorporating the detected eye or head position data the simulation system 1, and from that position data, the simulation system derives data values corresponding to the location coordinates of the eyepoint or eyepoints in the cockpit 7, and the direction and orientation of the field of view of the trainee.

System 1 is connected with one or more projectors or display devices 3 that each continually displays its out-the-window (OTW) view appropriate to the position in the virtual environment of the simulated vehicle. The multiple display screens 5 combine to provide an OTW view of the virtual environment as defined by the scene data for the trainee in the simulated cockpit 7. The display devices are preferably high-definition television or monitor projectors, and the screens 5 are preferably planar back-projection screens, so that the OTW scene is displayed in high resolution to the trainee.

The OTW video signals are preferably high-definition video signals transmitted according to common standards and formats, e.g. 1080 p or more advanced higher-definition standards. Each video signal comprises a sequential series of data fields or data packets each of which corresponds to a respective image frame of an OTW-view generated in real-time for the time instant of a current rendering duty cycle from the current state of the scene data by a 3-D rendering process that will be discussed below.

The simulation system 1 renders each frame of each video based on the stored scene data for the point in time of the particular rendering duty cycle and the location and orientation of the simulated vehicle in the virtual environment. This type of OTW scene simulation is commonly used in simulators, and is well known in the art.

The simulation computer system 1 also transmits a HMD video signal so as to be displayed to the trainee in a simulated HMD display device, e.g., visor 9, so that the trainee sees the OTW video projected on screen 5 combined with the HMD video on the HMD display device 9. The HMD video frames each contain imagery or symbology, such as text defining a target's identity or range, or forward looking infra-red (FLIR) imagery, and the HMD imagery is configured so that it superimposed over the objects in the OTW scene displayed on screens 5 to which the imagery or symbology relates. The HMD video signal itself comprises a sequence of data fields or packets each of which defines a respective HMD-image frame that is generated in real-time by the simulation system 1 for a respective point in time of the duty cycle of the HMD video.

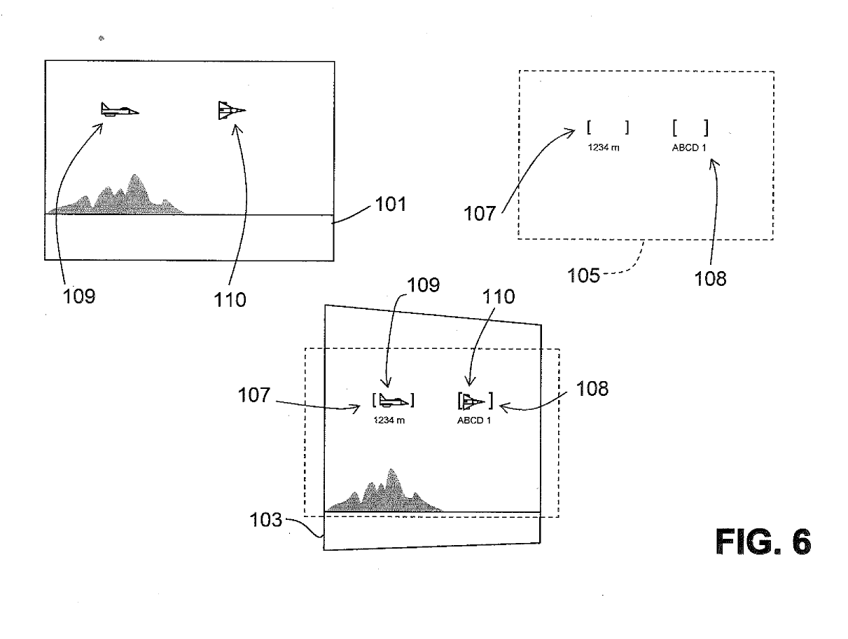

The simulation system 1 prepares the HMD video signal based in part on the head- or eye-tracker data, and transmits the HMD video so as to be displayed by a HMD display device, such as a head-mounted system having a visor 9, a beamsplitter structure (not shown) in the cockpit 7, or some other sort of HMD display device. The simulation uses the tracker data to determine the position of the imagery so that it aligns with the associated virtual objects in the OTW scene wherever the trainee's eye is positioned, even though the trainee may be viewing the display screen 5 at an angle such that the angular displacement relative to the trainee's eye between any objects in the OTW scene is different from the angle between those objects as seen from the design eyepoint. This is illustrated in FIG. 6, and this type of HMD simulation is known in the prior art. HMD systems that may be used in a simulator are discussed, for example in U.S. Pat. No. 6,369,952 issued Apr. 9, 2002 to Rallison et al., which is herein incorporated by reference. Another simulation system of this general type is described in the article “Real-time Engineering Flight Simulator” from the University of Sheffield Department of Automatic Control and Systems Engineering, available at www.fltsim.group.shef.ac.uk, also incorporated by reference.

As seen in FIG. 1, instructor or review computer station 11 is connected with the simulation system 1, and it displays and/or records what the pilot actually sees to allow an instructor to analyze the pilot's decision-making process during or after the training session. The instructor system 11 has a monitor 13, and simulation system 1 sends video in real-time during training to station 11 so as to be displayed on the monitor 13. This displayed video view is a representation of what the pilot is seeing from his viewpoint in the cockpit, i.e., the forward field of view that the pilot actually is looking at, i.e., the part of the projected OTW scene the pilot is facing and any HMD imagery superimposed on it by the simulated HMD device. The instruction or review station 11 is able also to record the video of the pilot's eye view, and to afterward play back the pilot's eye view as video to the instructor for analysis. The instructor computer station 11 also preferably is enabled to interact with simulation system 1 so that an instructor can access the simulation software system 1 via a GUI or other various input devices to select simulation scenarios, or otherwise administer the training of the pilot in simulation. Alternatively, the instructor station may be a simpler review station that is purely a recording station preserving a video of what the pilot sees as he or she goes through the training for replay and analysis afterward.

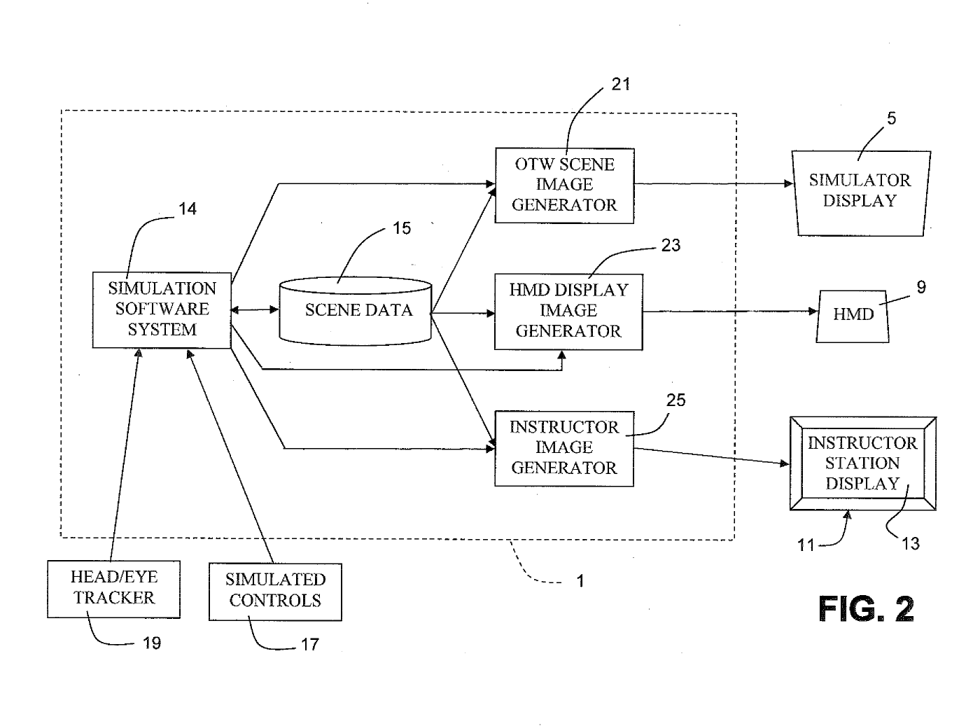

Referring to FIG. 2, the three-dimensional virtual environment of the simulation is defined by scene data 15 stored on a computer-accessible memory device operatively associated with the computer system(s) of simulation system 14. The scene data 15 comprises computer accessible stored data that defines each object, usually a surface or a primitive, in the virtual world by its location by definition of one or more points in a virtual world coordinate system, and its surface color or texture, or other appearance, and any other parameters relevant to the appearance of the object, e.g., transparency, when in the view of the trainee in the simulated world, as is well known in the art. The scene data is constantly or continually updated and modified by the simulation system 1 to represent the real-time virtual world of the simulation by simulation software system 14 and the behavior of the simulated vehicle as a consequence of any action by the pilot in a computer-supported model of the vehicle or aircraft being simulated, so that the vehicle moves in the three-dimensional virtual environment in a manner similar to the movement of the real vehicle in similar conditions in a real environment, as is well known in the art.

One or more computerized OTW scene image generators 21 periodically render images from the scene data 15 for the current OTW display once every display duty cycle, usually 60 Hz. Preferably, there is one image generator system per display screen of the simulator, and they all work in parallel to provide an OTW scene of combined videos surrounding the pilot in the simulator.

The present invention may be employed in systems that do not have a HMD simulation, but in the preferred embodiment a computerized HMD display image generator 23 receives symbology or other HMD data from the simulation software system 14, and from this HMD data and the scene data prepares the sequential frames of the HMD video signal every duty cycle of the video for display on HMD display device 9.

The video recorded by or displayed on display 13 of the instructor or review station is a series of image frames each created in a single-pass rendering by an instructor image generator 25 from the scene data based on the detected instantaneous point of view of the trainee in the simulator, and taking into account the perspective of the trainee's view of the associated display screen. This single-pass rendering is in contrast to a multiple-pass rendering, in which in a first pass an OTW scene would first be rendered, and then in a second pass the view of the OTW scene displayed on the screen as seen from the pilot's instantaneous point of view would be rendered by a second rendering pass, reducing the resolution of the first-pass rendering. Details of this single pass rendering will be set out below.

The image generator computer systems 21 and 25 operate using image generation software comprising stored instructions such as composed in OpenGL (Open Graphics Library) format so as to be executed by the respective host computer system processor(s). OpenGL is a cross-language and cross-platform application programming interface (“API”) for writing applications to produce three-dimensional computer graphics that affords access to graphics-rendering hardware, such as pipeline graphics processors that run in parallel to reduce processing time, on the host computer system. As an alternative to OpenGL, a similar API for writing applications to produce three-dimensional computer graphics, such as Microsoft's Direct3D, may also be employed in the image generators. The simulated HMD imagery also is generated using Open GL under SGI

OpenGL Performer on a PC running a Linux operating system. The image-generation process depends on the type of information of imagery displayed on the HMD. Usually, the HMD image generating computer receives a broadcast packet of data each duty cycle from the preliminary flight computer, a part of the simulation system. That packet contains specific HMD information data and it is used to formulate the current time-instant frame of video of the simulated HMD display. However, the HMD imagery may be generated by a variety of methods, especially where the HMD image is composed of purely simple graphic symbology, e.g., monochrome textual target information superimposed over aircraft found in the pilot's field of view in the OTW scene.

The OTW imagery is generated from the scene data by the image generators according to methods known in the art for rendering views of a 3D scene. The OTW images are rendered as views of the virtual world defined by the scene data for the particular duty cycle, as seen from a design eyepoint. The design eyepoint corresponds to a centerpoint in the cockpit, usually the midpoint between the eyes of the pilot when the pilot's head is in a neutral or centerpoint position in the cockpit 9, as that point in the ownship is defined in the virtual world of the scene data 15, and based on the calculated orientation of the simulated ownship in the virtual world. The location, direction and orientation of the field of view of the virtual environment from the design eyepoint is determined based on simulation or scene data defining the location and orientation of simulated ownship in the virtual world.

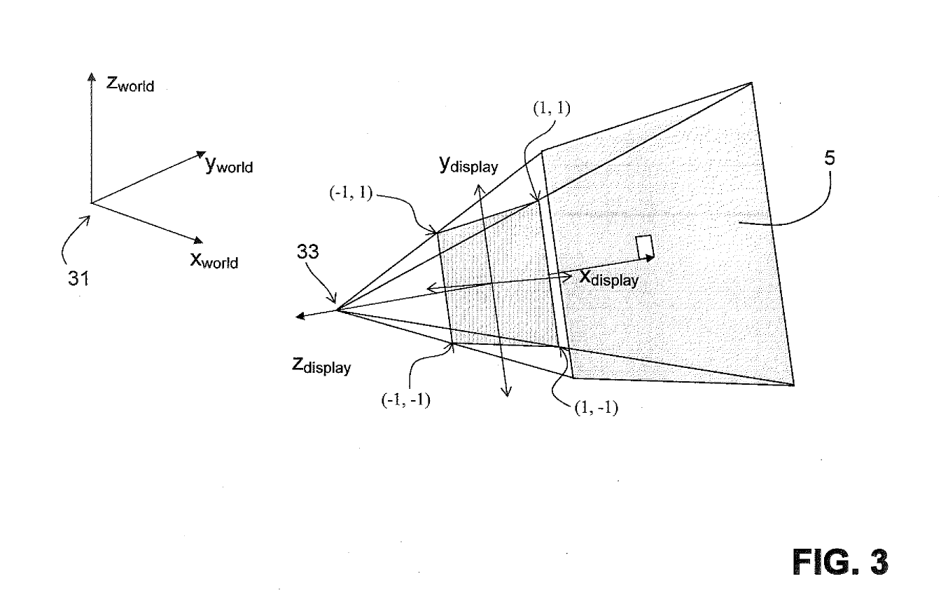

Referring to FIG. 3, the scene data includes stored data defining every object or surface, e.g., primitives, in the 3D model of the virtual space, and this data includes location data defining a point or points for each object or surface defining its location in a 3D-axis coordinate system (x_{world}, y_{world}, z_{world}) of the simulated virtual world, generally indicated at 31. For example, the location of a simple triangle primitive is defined by three vertex points in the world coordinate system. Other more complex surfaces or objects are defined with additional data fields stored in the scene data.

The rendering process for the OTW frame for a particular display screen makes use of a combination of many transformation matrices. Those matrices can be logically grouped into two categories,
(1) matrices that translate and rotate vertices of objects in world coordinates (x_{world}, y_{world}, z_{world}) to an axes system aligned with the view frustum and
(2) matrices that define the process to go from view frustum axes coordinates to projection plane coordinates.

In OpenGL, in general, the view frustum axes has its Z-axis perpendicular to the projection plane with the X-axis parallel to the “raster” lines (notionally left to right) and the Y-axis perpendicular to the raster lines (notionally bottom to top). What is of primary relevance to the present invention is the process used to go from view frustum axes coordinates (x_{vf}, y_{vf}, z_{vf}) to projection plane coordinates (xₚ, yₚ, zₚ).

The OpenGL render process is illustrated schematically in FIG. 10.

The OpenGL render process, including the projection component of the process, operates on homogenous coordinates. The simplest way to convert a 3D world coordinate of (x_{world}, y_{world}, z_{world}) to a homogenous world coordinate is to add a fourth component equal to one, e.g. (x_{world}, y_{world}, z_{world}, 1.0). The general form of the conversion is (w*x_{world}, w*y_{world}, w*z_{world}, w), so that to convert a homogenous coordinate (x, y, z, w) back to a 3D coordinate, the first three components are simply divided by the fourth, (x/w, y/w, z/w).

The projection process takes a view-frustum-axes homogeneous coordinate (x_{vf}, y_{vf}, z_{vf}, 1.0), and multiplies it by a 4×4 matrix that constitutes a transformation of view frustum axes to projection plane axes, and then the rendering pipeline converts the resulting projection-plane homogenous coordinate (xₚ, yₚ, zₚ, wₚ) to a 3D projection plane coordinate (xₚ/wₚ, yₚ/wₚ, zₚ/wₚ) or (xₚ′, yₚ′, zₚ′). The 3D projection plane coordinates are then used by the rendering process where it is assumed that xₚ′=−1 represents the left edge of the rendered scene, xₚ′=1 represents the right edge of the rendered scene, yₚ′=−1 represents the bottom edge of the rendered scene, yₚ′=1 represents the top edge of the rendered scene, and a zₚ′ between −1 and +1 needs to be included in the rendered scene. The value of zₚ′ is also used to prioritize the surfaces such that surfaces with a smaller zₚ′ are assumed to be closer to the viewpoint.

The OTW image generator operates according to known prior art rendering processes, and renders the frames of the video for the display screen by a process that includes a step of converting the virtual-world coordinates (x_{world}, y_{world}, z_{world}) of each object or surface in the virtual world to the viewing frustum homogeneous coordinates (x_{OTWvf}, y_{OTWvf}, z_{OTWvf}, 1.0). A standard 4×4 projection matrix conversion is then used to convert those to homogenous projection plane coordinates (x_{OTWp}, y_{OTWp}, z_{OTWp}, w_{OTWp}), those are then converted to 3D projection plane coordinates (x_{OTWp}′, y_{OTWp}′, z_{OTW}′) by the rendering pipeline and used to render the image as described above. That standard 4×4 matrix insures that objects or surfaces are scaled by an amount inversely proportional to the position in the z-dimension so that the two-dimensional x_{OTWp}′, y_{OTWp}′ depicts objects that are closer as larger than objects that are further away. The state machine defined by the OpenGL controls the graphics rendering pipeline so as to process a stream of coordinates of vertices of objects or surfaces in the virtual environment.

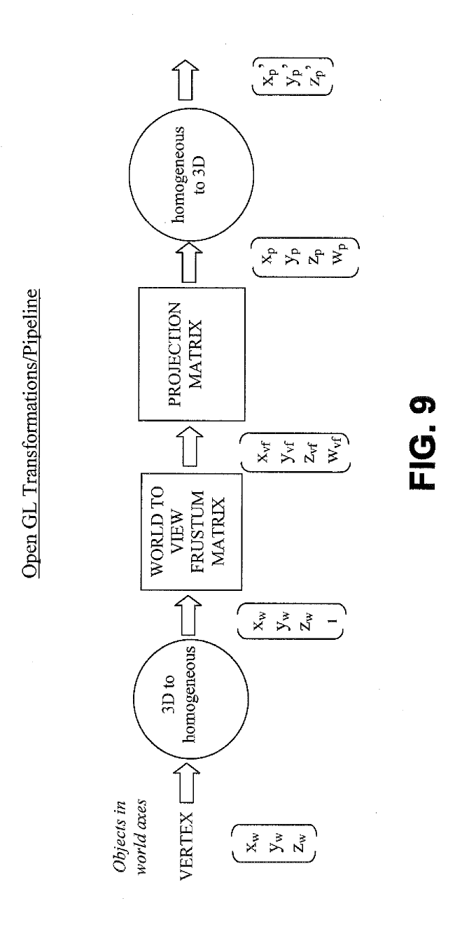

Referring to FIG. 9, the image generator host computer operates according to its rendering software so that it performs a matrix multiplication of each of the virtual world vertex coordinates (x_{world}, y_{world}, z_{world}, 1.0) of the objects defined in the scene data by a matrix that translates, rotates and otherwise transforms the world homogeneous coordinates (x_{world}, y_{world}, z_{world}, 1.0) to coordinates of the viewing frustum axes system (x_{vf}, y_{vf}, z_{vf}, 1.0). A second matrix transforms those to projection coordinates (xₚ, yₚ, zₚ, wₚ) with the rendering pipeline converting those to 3D projection plane coordinates (xₚ′, yₚ′, zₚ′) shown as (x_{display}, y_{display}, z_{display}) in FIG. 3. The object in virtual space that has the lowest value of zₚ′ for a given xₚ′, yₚ′ coordinate (i.e., a pixel location in the display screen) is the closest object to the design eyepoint, and that object is selected above all others having the same xₚ′, yₚ′ coordinate to determine the color assigned to that pixel in the rendering, with the color of the object defined by the scene data and other viewing parameters (e.g., illumination, transparency, specularity of the surface, etc.) as is well known in the art. The result is that each pixel has a color assigned to it, and the array of the data of all the pixels of the display constitutes the frame image, such as the OTW scene shown on screen 35 in FIG. 3.

In OpenGL implementation, both the view frustum axes matrix and the projection plane matrix often are 4×4 matrices that, used sequentially, convert homogeneous world coordinates (x_{world}, y_{world}, z_{world}) to coordinates of the projection plane axis system (xₚ, yₚ, zₚ, wₚ). Those matrices usually consist of 16 elements. In a 4×4 matrix process, each three element coordinate (x_{world}, y_{world}, z_{world}) is given a fourth coordinate which is appended to the three dimensional coordinates of the vertex making it a homogenous coordinate (x_{world}, y_{world}, z_{world}, w_{world}) where w_{world}=1.0.

As illustrated schematically in FIG. 2, the OTW scene generation for all the display screens is accomplished in the OTW scene image generator 21, which usually will provide a separate image generator computer for each OTW display screen so that all of the OTW frames for each point in time can be computed during each duty cycle.

In addition to the OTW rendering each duty cycle, the rendering of the instructor or review system view is also performed using a separate dedicated image generator 25. Image generator 25 provides a computerized rendering process that makes use of a specially prepared off-axis viewing projection matrix, as will be set out below. For the purposes of this disclosure, it should be understood that the calculations described here are electronically-based computerized operations performed on data stored electronically so as to correspond to matrix or vector mathematical operations.

Single-Pass Rendering

The systems and methods of the present invention achieve in a single rendering pass a perspective-correct image of the OTW scene projected on the display screen as actually seen as from the pilot's detected point of view. This is achieved by creating of special projection matrix, referred to herein as an off-axis projection matrix or parallax or perspective-transformed projection matrix, that is used in instructor image generator 25 to render the instructor/review station image frames in a manner similar to use of the standard projection matrix in the OTW image generator(s).

This parallax-view projection matrix is used in conjunction with the same view frustum axes matrix as used in rendering the OTW scene for the selected screen. The utilization of the OTW frustum followed by the parallax-view projection matrix transforms the virtual-world coordinates (x_{world}, y_{world}, z_{world}, 1.0) of the scene data to coordinates of a parallax-view projection plane axes (xₚᵥₚ, yₚᵥₚ, zₚᵥₚ, wₚᵥₚ), the rendering pipeline converting those to 3D coordinates (xₚᵥₚ′, yₚᵥₚ′, zₚᵥₚ′), the xₚᵥₚ′, yₚᵥₚ′ coordinates of which in the ranges −1≦xₚᵥₚ′≦1 and −1≦yₚᵥₚ′≦1 correspond to pixel locations in the frames of video displayed on instructor station display or stored in the review video recorder, and ultimately represents a perspective-influenced view of the OTW projection screen from the detected eyepoint of the pilot.

This parallax-view projection matrix is a 3×3 or 4×4 matrix that is derived by computer manipulation based upon the current screen and detected eyepoint of the pilot in the point in time of the current duty cycle.

First, the instructor or review image generator computer system 25 determines which of the display screens the trainee is looking at.

The relevant computer system deriving the parallax projection matrix then either receives or itself derives data defining elements of the 3×3 or 4×4 OTW view frustum axes matrix for the screen at which the trainee is looking for the design eyepoint in the virtual world.

Next, the simulation software system 14 or the instructor or review image generator system 25 derives the perspective-distorted projection plane matrix based on the detected position of the head of the pilot and on stored data that defines the position in the real world of the simulator of the projection screen or screens being viewed. The derivation may be accomplished by the relevant computer system 14 or 25 performing a series of calculation steps modifying the stored data representing the current OTW projection matrix for the display screen. It may also be done by the computer system deriving a perspective transformation matrix converting the coordinates of the OTW view frustum axes system (x_{OTWvf}, y_{OTWvf}, z_{OTWvf}, 1.0) to the new coordinate system (xₚᵥₚ, yₚᵥₚ, zₚᵥₚ, wₚᵥₚ) of the instructor/review station with perspective for the actual eyepoint, and then multiplying those matrices together, yielding a the pilot parallax-view projection matrix. In either case, the computations that derive the stored data values of the perspective transformation matrix are based on the detected position of the pilot's eye in the simulator, the orientation of the pilot's head, and the location of the display screen relative to that detected eyepoint.

Once a matrix is obtained for transforming the world coordinates (x_{world}, y_{world}, z_{world}) to view frustum axes coordinates (x_{OTWvf}, y_{OTWvf}, z_{OTWvf}, 1.0), the instructor station view is derived by the typical rendering process in which the view frustum coordinates of each object in the scene data is multiplied by the perspective-distorted matrix resulting in perspective distorted projection coordinate (xₚᵥₚ, yₚᵥₚ, zₚᵥₚ, wₚᵥₚ,) which the rendering pipeline then converts to 3D coordinates (xₚᵥₚ′, yₚᵥₚ′, zₚᵥₚ′) the color for each display screen point (xₚᵥₚ′, yₚᵥₚ′) is selected based on the object having the lowest value of zₚᵥₚ′ for that point.

The derivation of stored data values that correspond to elements of a matrix that transforms the OTW view frustum axes coordinates to the parallax pilot-view projection axes can be achieved by the second image generator using one of at least two computerized processes disclosed herein.

In one embodiment, intersections of the display screen with five lines of sight in an axes system of the pilot's instantaneous viewpoint are determined, and these intersections become the basis of computations that result in the parallax projection matrix, eventually requiring the computerized calculation of data values for up to twelve (12) of the sixteen (16) elements of the 4×4 projection matrix, as well as a step of the computer taking a matrix inverse, as will be set out below.

In another embodiment, display screen intersections of only three lines of sight in an axes system of the pilot's instantaneous viewpoint are determined, and these are used in the second image generator to determine the elements of the parallax projection matrix. This second method uses a different view frustum axes matrix that in turn simplifies the determination of the stored data values of the parallax projection matrix by a computer, and does not require the determination of a matrix inverse, which reduces computation time. This second method determines the parallax projection matrix by calculating new data values for only six elements of the sixteen-element 4×4 matrix, with the data values for the two other elements identical to those used by the normal perspective OTW projection matrix, as will be detailed below.

First Method of Creating Parallax Projection Matrix

The required rendering transform that converts world coordinates to view frustum axes is established in the standard manner using prior art. In this case, the view frustum axes system is identical to the one used in the OTW rendering for the selected display screen. In OpenGL conventions, the z-axis is perpendicular to the display screen positive towards the design eye point from the screen, the x-axis paralleling the “raster” lines positive with increasing pixel number (notionally left to right) with the y-axis perpendicular to the “raster line” positive with decreasing line number (notionally bottom to top). For the First Method, the view frustum axes can therefore be thought of as the screen axes and will be used interchangeably herein.

The pilot-view parallax projection matrix that is used for the one-pass rendering of the instructor view may be derived by the following method.

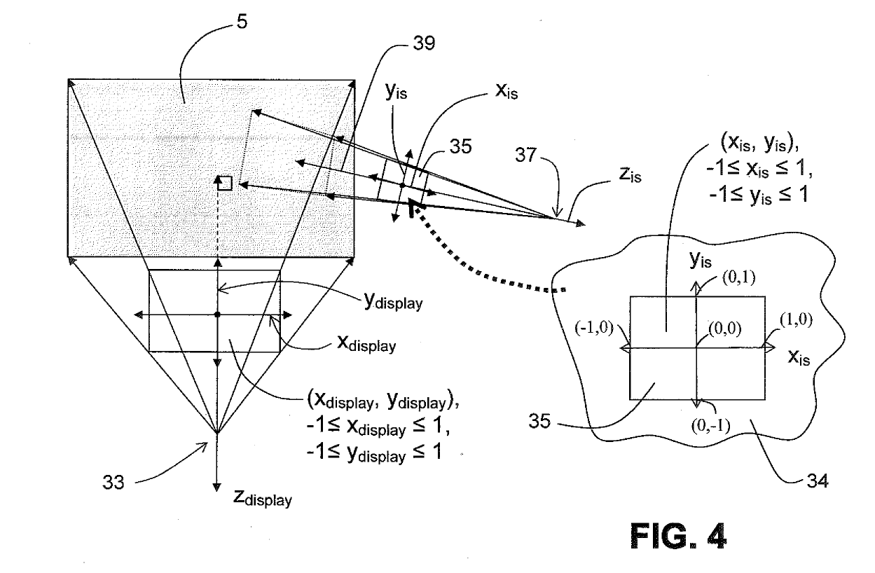

Referring to FIG. 4, the rendering of the instructor or review station view is accomplished using computerized calculations based on a third rendering coordinate axis system for the instructor or review station view. That coordinate system has coordinates (xᵢₛ, yᵢₛ, zᵢₛ) based upon a plane 34 defining the instructor display screen 35 (i.e., the planar field of view of the instructor display screen). The center of this screen is xᵢₛ=0, and yᵢₛ=0, with zᵢₛ expressing distance from the display. The negative zᵢₛ axis corresponds to the actual detected line of sight 39 of the pilot. The actual eyepoint 37 is at (0, 0, 0) in this coordinate system.

The review station image generator receives detected eyepoint data derived from the head or eye tracking system. That data defines the location of the eye or eyes of the trainee in the cockpit, and also the orientation of the eye or head of the trainee, i.e., the direction and rotational orientation of the trainee's eye or head corresponding to which way he is looking. In the preferred embodiment, the location of the trainee's eye VPₒₛ is expressed in data fields VPₒₛ=(VPₓ, VP_{y}, VP_{z}) corresponding to three-dimensional coordinates of the detected eyepoint in the display coordinate system (x_{display}, y_{display}, z_{display}) in which system the design eyepoint is the origin, i.e. (0, 0, 0), and the detected actual viewpoint orientation is data with values for the viewpoint azimuth, elevation and roll, VP_{AZ}, VP_{EL}, VP_{ROLL}, respectively, relative to the display coordinate system.

Every rendering cycle, based on the detected eyepoint and line of sight orientation of the pilot's eye or head, the rendering computer system determines which display screen 5 of the simulator the trainee is looking at. When the screen is identified, the system accesses stored screen-position data that defines the positions of the various display screens in the simulator so as to obtain data defining the plane of the screen that the trainee is looking at. This data includes coefficients Sₓ, S_{y}, S_{z}, S₀ of an equation defining the plane of the screen according to the equation

Sₓx+S_{y}y+S_{z}z+S₀=0

again, in the display coordinate system (x_{display}, y_{display}, z_{display}) in which the design eyepoint, also the design eye point of the simulator cockpit, is (0, 0, 0).

Given that the rendering system receives the transformation matrix that takes world coordinates to view frustum axes, in this case synonymous with screen axes, the rendering pipeline (i.e., the series of computer data processors that perform the rendering calculations) also requires the transformation matrix (pilot-view parallax projection matrix—the matrix which is being derived) that takes screen axis coordinates to projection axis coordinates where the rendering pipeline then performs a projection as discussed previously. Let that pilot-view parallax projection matrix be labeled as PM herein with individual elements defined as:

$$PM = [ \begin{matrix}{PM}_{11} & {PM}_{12} & {PM}_{13} \\ {PM}_{21} & {PM}_{22} & {PM}_{23} \\ {PM}_{31} & {PM}_{32} & {PM}_{33}\end{matrix} ]$$

A 3×3 matrix is used for the single pass rendering derivation rather than the homogenous 4×4 just for simplification. It was shown previously that the pipeline performs the projection of homogenous coordinates simply by converting those coordinates to 3D, dividing the first three components by the fourth. A similar process is required when projecting 3D coordinates, where the first two components are divided by the third as follows. This matrix converts values of coordinates in view frustum axes (x_{vf}, y_{vf}, z_{vf}) or screen axis in this case (xₛ, yₛ, zₛ) to the projection plane coordinates (xᵢₛ, yᵢₛ, zᵢₛ) by the calculation

$$[ \begin{matrix}{x}_{is} \\ {y}_{is} \\ {z}_{is}\end{matrix} ] = PM [ \begin{matrix}{x}_{s} \\ {y}_{s} \\ {z}_{s}\end{matrix} ]$$

The coordinate value (xᵢₛ, yᵢₛ, zᵢₛ) is then scaled by division by zᵢₛ in the rendering pipeline so that the projected coordinates for the instructor station display are (xᵢₛ′, yᵢₛ′) or, if expressed in terms of the individual elements of the projection matrix M,

$${x}_{is}^{′} = \frac{{PM}_{11} {x}_{s} + {PM}_{12} {y}_{s} + {PM}_{13} {z}_{s}}{{PM}_{31} {x}_{s} + {PM}_{32} {y}_{s} + {PM}_{33} {z}_{s}}$$

$${y}_{is}^{′} = \frac{{PM}_{21} {x}_{s} + {PM}_{22} {y}_{s} + {PM}_{23} {z}_{s}}{{PM}_{31} {x}_{s} + {PM}_{32} {y}_{s} + {PM}_{33} {z}_{s}}$$

The PM matrix must be defined such that the scaled coordinates when computed by the rendering pipeline (xᵢₛ′, yᵢₛ′) result in values of −1≦xᵢₛ′≦1 and −1≦yᵢₛ′≦1 when within the boundaries of the instructor station display. Notice that since this is a projection matrix (resultant xᵢₛ and yᵢₛ always divided by zᵢₛ to compute xᵢₛ′ and yᵢₛ′) that there is a set of projection matrices that will satisfy the above such that given a projection matrix PM that satisfies the above, PM′ will also satisfy the above where:

PM′=k·PM where k≠0

That becomes the basis for computing the projection transform matrix needed for a perspective-distorted single-pass rendering for the actual viewpoint looking at the virtual world as presented on the relevant display screen, as set out below.

Step 1: A rotation matrix Q is calculated that converts the coordinate axes of the actual viewpoint orientation, same as instructor station axes to OTW display axes using the data values VP_{AZ}, VP_{EL}, VP_{ROLL}. A second rotation matrix R is calculated that converts OTW display axes to screen axes (view frustum axes) based upon the selected screen; this is a matrix that is most likely also part of the standard world to view frustum axes transformation.

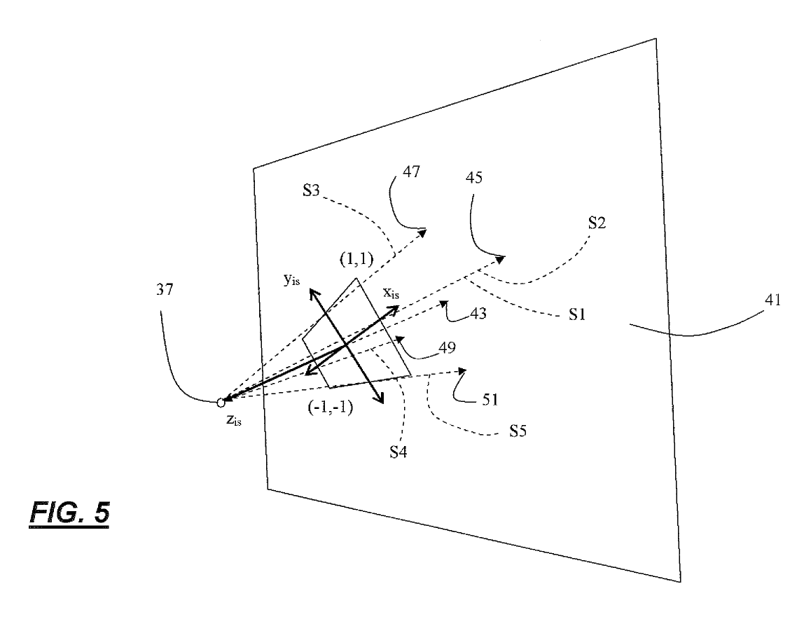

Step 2: Given a vector in the pilot's instantaneous view point axes (xᵢₛ, yᵢₛ, zᵢₛ), the associated coordinate in screen (xₛ, yₛ, zₛ) or view frustum axes (x_{vf}, y_{vf}, z_{vf}) can be found as follows as illustrated in FIG. 5 (note: the screen and view frustum axes are the same):
a) The vector (xᵢₛ, yᵢₛ, zᵢₛ) is rotated into the display axes using the rotation matrix Q.
b) The above vector in display axes and the view point coordinate (VPₓ, VP_{y}, VP_{z}) also in display axes is used to find a screen intersection using the coefficients Sₓ, S_{y}, S_{z}, S₀ of an equation defining the plane 41 of the screen also in display axes.
c) The resulting screen intersection coordinate is then rotated into screen or more familiar view frustum axes using the rotation matrix R.
Subsequent steps rely on the determination of five vectors:
S1: the vector from the actual eyepoint through a point (xᵢₛ, yᵢₛ, zᵢₛ) where (xᵢₛ′, yᵢₛ′)=(0,0), i.e., the center midpoint of the, instructor's repeat display. In FIG. 5 this vector intersects the screen plane 41 at point 43 (defined by the equation Sₓ·x+S_{y}·y+S_{z}·z+S₀=0).
S2: the vector from the actual eyepoint through a point (xᵢₛ, yᵢₛ, zᵢₛ) where (xᵢₛ′, yᵢₛ′)=(1,0), i.e., the right edge midpoint of the instructor's repeat display (point 45 where that vector meets the plane 41 of the display screen).
S3: the vector from the actual eyepoint through a point (xᵢₛ, yᵢₛ, zᵢₛ) where (xᵢₛ′, yᵢₛ′)=(0,1) on the screen, i.e., the top edge midpoint of the instructor's repeat display (point 47 where that vector meets the plane 41 of the display screen).
S4: the vector from the actual eyepoint through a point (xᵢₛ, yᵢₛ, zᵢₛ) where (xᵢₛ′, yᵢₛ′)=(−1,0) on the screen, i.e., the left edge midpoint of the instructor's repeat display (point 49 where that vector meets the plane 41 of the display screen).
S5: the vector from the actual eyepoint through a point (xᵢₛ, yᵢₛ, zᵢₛ) where (xᵢₛ′, yᵢₛ′)=(0,−1) on the screen, i.e., the frame bottom edge midpoint of the instructor's repeat display (point 51 where that vector meets the plane 41 of the display screen).

In other words, the vector Si is the vector from the eyepoint at the center of the instructor screen in the direction of view based on the VPₚₒₛ and the azimuth, elevation and roll values VP_{AZ}, VP_{EL}, VP_{ROLL} to the point that is struck on the projection screen by that line of sight and then rotated into view frustum or screen axes. The other vectors are similarly vectors from the eyepoint to where the line of sight strikes the projection screen through the respective xᵢₛ, yᵢₛ screen coordinates as oriented per the values of VP_{AZ}, VP_{EL}, VP_{ROLL}.
Step 3: The computer then determines the elements of the normal vector to the plane passing through \vec{S}1 and \vec{S}3 and the design eyepoint, and the normal vector to the plane passing through \vec{S}1 and \vec{S}2 and the design eyepoint by the equations:

$${\vec{N}}_{XO} = \frac{\vec{S } 1 \times \vec{S} 3}{\vert \vec{S } 1 \times \vec{S} 3 \vert} \qquad {\vec{N}}_{XO} = {a}_{xo} , {b}_{xo} , {c}_{xo}$$

$${\vec{N}}_{YO} = \frac{\vec{S } 1 \times \vec{S} 2}{\vert \vec{S } 1 \times \vec{S} 2 \vert} \qquad {\vec{N}}_{YO} = {a}_{yo} , {b}_{yo} , {c}_{yo}$$

\vec{N}_{XO} is the normal to the plane where xᵢₛ′=0, and \vec{N}_{YO} is the normal to the plane where yᵢₛ′=0. Each is a three-element vector of three determined numerical values, i.e.,

$${\vec{N}}_{XO} = [ \begin{matrix}{a}_{XO} \\ {b}_{XO} \\ {c}_{XO}\end{matrix} ] and {\vec{N}}_{YO} = [ \begin{matrix}{a}_{YO} \\ {b}_{YO} \\ {c}_{YO}\end{matrix} ]$$

It should be noted at this point that the above planes pass through the design eye point which is the origin (0, 0, 0) of both the display axes and the screen or view frustum axes. The fourth component of the plane coefficients that relates those plane's distances from the origin is therefore zero. Therefore for those planes, the dot product of their plane normals (a, b, c) with any point (x, y, z) that falls on that respective plane will be equal to zero, or, when expressed as an equation:

a·x+b·y+c·z=0 for all (x, y, z)s that lie on a plane that contains the origin

After this step, the computer system then populates the elements of a 3×3 matrix PM that converts (xₛ, yₛ, zₛ) coordinates to perspective distorted instructor review station coordinates (xᵢₛ, yᵢₛ, zᵢₛ), i.e.,

$$[ \begin{matrix}{x}_{is} \\ {y}_{is} \\ {z}_{is}\end{matrix} ] = PM [ \begin{matrix}{x}_{s} \\ {y}_{s} \\ {z}_{s}\end{matrix} ]$$

The matrix PM has the elements as follows:

$$PM = [ \begin{matrix}{PM}_{11} & {PM}_{12} & {PM}_{13} \\ {PM}_{21} & {PM}_{22} & {PM}_{23} \\ {PM}_{31} & {PM}_{32} & {PM}_{33}\end{matrix} ]$$

The first two rows of the matrix PM are expressed as constant multiples of the normal vectors \vec{N}_{XO} and Rya This is because, for any point xₛ, yₛ, zₛ that falls on the xᵢₛ′-axis of the review screen plane,

$${x}_{is}^{′} = \frac{{PM}_{11} \cdot {x}_{s} + {PM}_{12} \cdot {y}_{s} + {PM}_{13} \cdot {z}_{s}}{{PM}_{31} \cdot {x}_{s} + {PM}_{32} \cdot {y}_{s} + {PM}_{33} \cdot {z}_{s}} = 0$$

and also \vec{N}_{XO}·(xₛ, yₛ, zₛ)=aₓₒ·xₛ+bₓₒ·yₛ+cₓₒ·zₛ=0

Similarly, for any point xₛ, yₛ, zₛ that falls on the yᵢₛ′-axis of the review screen plane,

$${y}_{is}^{′} = \frac{{PM}_{21} \cdot {x}_{s} + {PM}_{22} \cdot {y}_{s} + {PM}_{23} \cdot {z}_{s}}{{PM}_{31} \cdot {x}_{s} + {PM}_{32} \cdot {y}_{s} + {PM}_{33} \cdot {z}_{s}} = 0$$

and also \vec{N}_{YO}·(xₛ, yₛ, zₛ)=a_{yo}·xₛ+b_{y0}+yₛ+c_{yo}·zₛ=0.

Therefore

PM₁₁=Kₓₒ·aₓₒ, PM₁₂=Kₓₒ·bₓₒ, PM₁₃=Kₓₒ·cₓₒ

PM₂₁=K_{yo}·a_{yo}, PM₂₂=K_{yo}·b_{yo}, PM₂₃=K_{yo}·c_{yo}

Where

Kₓₒ≠0

L_{yo}≠0

Substituting

$$PM = [ \begin{matrix}{K}_{xo} \cdot {a}_{xo} & {K}_{xo} \cdot {b}_{xo} & {K}_{xo} \cdot {c}_{xo} \\ {K}_{yo} \cdot {a}_{yo} & {K}_{yo} \cdot {b}_{yo} & {K}_{yo} \cdot {c}_{yo} \\ {PM}_{31} & {PM}_{32} & {PM}_{33}\end{matrix} ]$$

Given that PM′ results in the same projection where

$${PM}^{ ′} = \frac{1}{{K}_{yo}} \cdot [ \begin{matrix}{K}_{xo} \cdot {a}_{xo} & {K}_{xo} \cdot {b}_{xo} & {K}_{xo} \cdot {c}_{xo} \\ {K}_{yo} \cdot {a}_{yo} & {K}_{yo} \cdot {b}_{yo} & {K}_{yo} \cdot {c}_{yo} \\ {PM}_{31} & {PM}_{32} & {PM}_{33}\end{matrix} ]$$

Then

$${PM}^{ ′} = [ \begin{matrix}{K}_{xo}^{′} \cdot {a}_{xo} & {K}_{xo}^{′} \cdot {b}_{xo} & {K}_{xo}^{′} \cdot {c}_{xo} \\ {a}_{yo} & {b}_{yo} & {c}_{yo} \\ {PM}_{31}^{′} & {PM}_{32}^{′} & {PM}_{33}^{′}\end{matrix} ]$$

Where

$${K}_{xo}^{′} = \frac{{K}_{xo}}{{K}_{yo}}$$

The values of a_{X0}, b_{X0}, c_{Y0}, a_{Y0}, b_{Y0}, and c_{Y0} were derived in step 3 above.

The five variables PM′₃₁, PM′_{32 , PM′}₃₃, Kₓₒ and K_{yo} are related by the following formulae based on the vectors \vec{S}2, \vec{S}4, \vec{S}3, and \vec{S}5 due to the values of xᵢₛ′ or yᵢₛ′ at those points.

For \vec{S}2,

$${x}_{is}^{′} = 1 = \frac{{K}_{xo}^{′} \cdot ( {\vec{N}}_{xo} \cdot \vec{S} 2 )}{{PM}_{31}^{′} \cdot \vec{S} {2}_{x} + {PM}_{32}^{′} \cdot \vec{S} {2}_{y} + {PM}_{33}^{′} \cdot \vec{S} {2}_{z}}$$

and therefore

PM′₃₁·\vec{S}2ₓ+PM′₃₂·\vec{S}2_{y}+PM′₃₃·\vec{S}2_{z}=Kₓₒ′·(\vec{N}ₓₒ·\vec{S}2).

For \vec{S}4,

$${x}_{is}^{′} = - 1 = \frac{{K}_{xo}^{′} \cdot ( {\vec{N}}_{xo} \cdot \vec{S} 4 )}{{PM}_{31}^{′} \cdot \vec{S} {4}_{x} + {PM}_{32}^{′} \cdot \vec{S} {4}_{y} + {PM}_{33}^{′} \cdot \vec{S} {4}_{z}}$$

and therefore

PM′₃₁·\vec{S}4ₓ+PM′₃₂·\vec{S}4_{y}+PM′₃₃·\vec{S}4_{z}=−Kₓₒ′·(\vec{N}ₓₒ·\vec{S}4)

For \vec{S}3,

$${y}_{is}^{′} = 1 = \frac{( {\vec{N}}_{yo} \cdot \vec{S} 3 )}{{PM}_{31}^{′} \cdot \vec{S} {3}_{x} + {PM}_{32}^{′} \cdot \vec{S} {3}_{y} + {PM}_{33}^{′} \cdot \vec{S} {3}_{z}}$$

and therefore

PM′₃₁·\vec{S}3ₓ+PM′₃₂·\vec{S}3_{y}+PM′₃₃·\vec{S}3_{z}=(\vec{N}_{yo}·\vec{S}3)

For \vec{S}5,

$${y}_{is}^{′} = - 1 = \frac{( {\vec{N}}_{yo} \cdot \vec{S} 5 )}{{PM}_{31}^{′} \cdot \vec{S} {5}_{x} + {PM}_{32}^{′} \cdot \vec{S} {5}_{y} + {PM}_{33}^{′} \cdot \vec{S} {5}_{z}}$$

and therefore

PM′₃₁·\vec{S}5ₓ+PM′₃₂·\vec{S}5_{y}+PM′₃₃·\vec{S}5_{z}=−(\vec{N}_{yo}·\vec{S}5)

To completely determine all elements of PM′, the system further computes the values of the elements PM′₃₁, PM′₃₂, PM′₃₃, and K′_{X0} by the following computerized calculations.

Step 4: With the three equations from Step 3 above involving vectors S2, S3 and S5 forming a system of equations such that

$$[ \begin{matrix}\vec{S} {2}_{x} & \vec{S} {2}_{y} & \vec{S} {2}_{z} \\ \vec{S} {3}_{x} & \vec{S} {3}_{y} & \vec{S} {3}_{z} \\ \vec{S} {5}_{x} & \vec{S} {5}_{y} & \vec{S} {5}_{z}\end{matrix} ] \cdot [ \begin{matrix}{PM}_{31}^{′} \\ {PM}_{32}^{′} \\ {PM}_{33}^{′}\end{matrix} ] = [ \begin{matrix}{K}_{xo}^{′} \cdot ( {\vec{N}}_{xo} \cdot \vec{S} 2 ) \\ ( {\vec{N}}_{xo} \cdot \vec{S} 3 ) \\ - ( {\vec{N}}_{yo} \cdot \vec{S} 5 )\end{matrix} ]$$

The computer system formulates a matrix S as follows:

$$S = [ \begin{matrix}\vec{S} {2}_{x} & \vec{S} {2}_{y} & \vec{S} {2}_{z} \\ \vec{S} {3}_{x} & \vec{S} {3}_{y} & \vec{S} {3}_{z} \\ \vec{S} {5}_{x} & \vec{S} {5}_{y} & \vec{S} {5}_{z}\end{matrix} ]$$

and then calculates a matrix SI, which is the inverse of matrix S, therefore. This matrix SI satisfies the following equation:

$$[ \begin{matrix}{PM}_{31}^{′} \\ {PM}_{32}^{′} \\ {PM}_{33}^{′}\end{matrix} ] = [ \begin{matrix}{SI}_{11} & {SI}_{12} & {SI}_{13} \\ {SI}_{21} & {SI}_{22} & {SI}_{23} \\ {SI}_{31} & {SI}_{32} & {SI}_{33}\end{matrix} ] \cdot [ \begin{matrix}{K}_{xo}^{′} \cdot ( {\vec{N}}_{xo} \cdot \vec{S} 2 ) \\ ( {\vec{N}}_{xo} \cdot \vec{S} 3 ) \\ - ( {\vec{N}}_{yo} \cdot \vec{S} 5 )\end{matrix} ]$$

or, dividing the SI matrix into its constituent vectors:

$$[ \begin{matrix}{PM}_{31}^{′} \\ {PM}_{32}^{′} \\ {PM}_{33}^{′}\end{matrix} ] = [ \begin{matrix}{SI}_{11} \\ {SI}_{21} \\ {SI}_{31}\end{matrix} ] \cdot {K}_{xo}^{′} \cdot ( {\vec{N}}_{xo} \cdot \vec{S} 2 ) + [ \begin{matrix}{SI}_{12} & {SI}_{13} \\ {SI}_{22} & {SI}_{23} \\ {SI}_{32} & {SI}_{33}\end{matrix} ] \cdot [ \begin{matrix}( {\vec{N}}_{xo} \cdot \vec{S} 3 ) \\ - ( {\vec{N}}_{yo} \cdot \vec{S} 5 )\end{matrix} ]$$

meaning that the stored data values of the bottom row elements PM′₃₁, PM′₃₂, PM′₃₃ are calculated by the following operation:

$$[ \begin{matrix}{PM}_{31}^{′} \\ {PM}_{32}^{′} \\ {PM}_{33}^{′}\end{matrix} ] = {K}_{xo}^{′} \cdot \vec{Q} + \vec{R}$$

$$Where \vec{Q} = [ \begin{matrix}{SI}_{11} \\ {SI}_{21} \\ {SI}_{31}\end{matrix} ] \cdot ( {\vec{N}}_{xo} \cdot \vec{S} 2 ) and$$

$$\vec{R} = [ \begin{matrix}{SI}_{12} & {SI}_{13} \\ {SI}_{22} & {SI}_{23} \\ {SI}_{32} & {SI}_{33}\end{matrix} ] \cdot [ \begin{matrix}( {\vec{N}}_{xo} \cdot \vec{S} 3 ) \\ - ( {\vec{N}}_{yo} \cdot \vec{S} 5 )\end{matrix} ]$$

Step 5: The system next determines a value of Kₓₒ′, using an operation derived by rewriting the equation from Step 3 containing S4:

$$[ \begin{matrix}{PM}_{31}^{′} \\ {PM}_{32}^{′} \\ {PM}_{33}^{′}\end{matrix} ] \cdot \vec{S} 4 = - {K}_{xo}^{′} \cdot ( {\vec{N}}_{xo} \cdot \vec{S} 4 )$$

and substituting Kₓₒ′·\vec{Q}+\vec{R} for

$$[ \begin{matrix}{PM}_{31}^{′} \\ {PM}_{32}^{′} \\ {PM}_{33}^{′}\end{matrix} ]$$

as found in Step 4 above yields the following relation:

(Kₓₒ′·\vec{Q}+\vec{R})·\vec{S}4=−Kₓₒ′·(\vec{N}ₓₒ\vec{S}4)

The system therefore calculates the value of Kₓₒ′ by the formula:

$${K}_{xo}^{′} = \frac{- \vec{R} \cdot \vec{S} 4}{[ \vec{Q} \cdot \vec{S} 4 - {\vec{N}}_{xo} \cdot \vec{S} 4 ]}$$

Step 6: The system stores the values of the first two rows of PM determined as follows using the determined value of K′_{X0}:

PM′₁₁=Kₓₒ′·aₓₒ, PM′₁₂=Kₓₒ′·bₓₒ, PM′₁₃=Kₓₒ′·cₓₒ

PM′₂₁=a_{yo}, PM′₂₂=b_{yo}, PM′₂₃=c_{yo}.

Step 7: The system computes the third row of PM' by the following calculation:

$$[ \begin{matrix}{PM}_{31}^{′} \\ {PM}_{32}^{′} \\ {PM}_{33}^{′}\end{matrix} ] = {K}_{xo}^{′} \cdot \vec{Q} + \vec{R}$$

and then stores the values of the last row in appropriate data areas for matrix PM′.

Step 8: Finally and arbitrarily (already shown that scaling does not effect the perspective projection) the matrix PM′ is resealed by the magnitude of the third row by the following calculation:

$${PM}^{′} = \frac{{PM}^{′}}{\vert [ \begin{matrix}{PM}_{31}^{′} \\ {PM}_{32}^{′} \\ {PM}_{33}^{′}\end{matrix} ] \vert}$$

The PM′ matrix is recalculated afresh by the steps of this method each duty cycle of the instructor review station video rendering system, e.g., at 60 Hz.

Second Method of Creating Parallax Projection Matrix

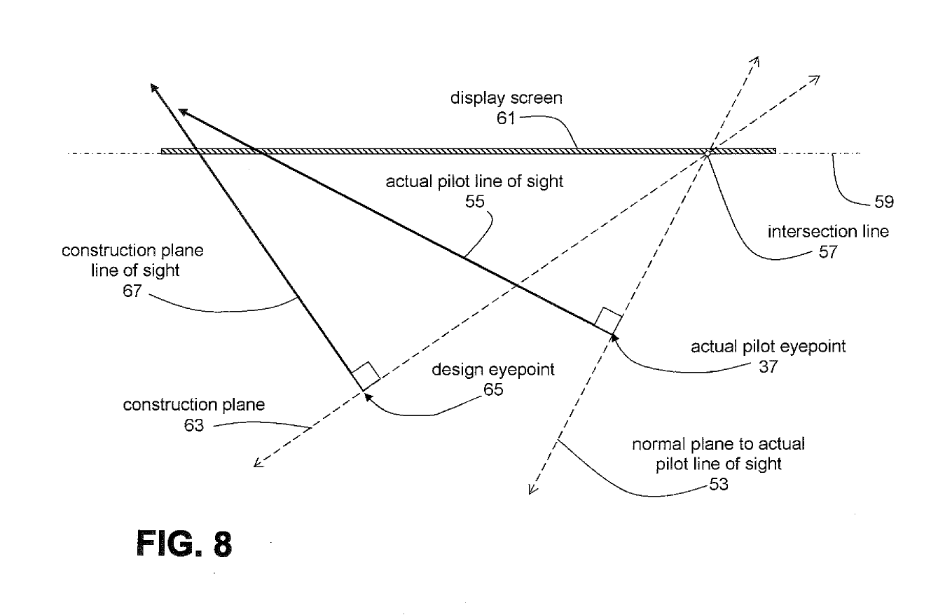

The second method of creating a 3×3 matrix still results in a matrix that converts view frustum axes (x_{vf}, y_{vf}, z_{vf}) coordinates to perspective distorted instructor review station coordinates (xᵢₛ, yᵢₛ, zᵢₛ)). The difference between the first and second method is that the view frustum axes no longer parallels the OTW screen, but rather it parallels a theoretical or fictitious plane that is constructed using the OTW screen plane and the actual pilot eye point geometry. This geometrical relationship is illustrated in FIG. 8, and is described below. Using the constructed plane reduces some of the computations when generating the perspective distortion transformation matrix. This is a significant benefit because there is a limited computational period available for each display cycle.

There exists a system of axes, herein referred to as the construction axes x_{c}, y_{c}, z_{c}, that simplifies some of the computations. In that system of axes the matrix derived has elements according to the equation

$$PM = [ \begin{matrix}{PM}_{11} & {PM}_{12} & {PM}_{13} \\ {PM}_{21} & {PM}_{22} & {PM}_{23} \\ 0 & 0 & - 1\end{matrix} ]$$

Referring to the diagram of FIG. 8, the construction axis system is derived by the following series of computer-executed mathematical operations performed after the data referenced in:
1. The plane 53 passing through the actual detected pilot eyepoint 37 and perpendicular to the line of sight 55 as defined by VP_{AZ}, and VP_{EL} is determined.
2. The line 57 formed by the intersection of that plane 53 with the plane 59 of the screen 61 is determined.
3. The construction plane 63, the plane containing the design eyepoint 65, (0, 0, 0) in the cockpit display coordinate system x_{display}, y_{display}, z_{display}, and the intersection line 57, is determined. This plane 63 contains the x_{c} and y_{c} axes of the construction axis system.
4. The z-axis or line of sight 67 of the construction axis system is determined as the normal to the construction plane 63.
5. Values C_{AZ} and C_{EL}, defining the azimuth and elevation of the line of sight (i.e., the z_{c}-axis of the construction axes), are derived from the determined line of sight. The roll of the construction axis, Cᵣₒₗₗ, is arbitrary and is therefore set to zero for simplicity.
6. A rotation matrix Q is calculated that converts the coordinate axes of the actual viewpoint orientation, same as instructor station, axes to OTW display axes using the data values VP_{AZ}, VP_{EL}, VP_{ROLL}. A second rotation matrix R is calculated that converts OTW display axes coordinates (x_{display}, y_{display}, z_{display}) to construction axes coordinates (x_{c}, y_{c}, z_{c}) or view frustum axes coordinates (x_{vf}, y_{vf}, z_{vf}) based upon C_{AZ}, C_{EL} and Cᵣₒₗₗ from the above step. The second matrix (R) is also used as part of the initial rendering transform that converts world coordinates (x_{world}, y_{world}, z_{world}) or (xₛ, yₛ, zₛ) to view frustum axes coordinates (x_{vf}, y_{vf}, z_{vf}) or constructions axes coordinates (x_{c}, y_{c}, z_{c}) which are equivalent in this second method of generating the PM matrix.
7. The system determines the following vectors from the actual eyepoint to the point where the respective line of sight reaches the screen, defined as for the first method described above and as illustrated by FIG. 5:
S1: the vector from the actual eyepoint through a point (xᵢₛ, yᵢₛ, zᵢₛ) where (xᵢₛ′, yᵢₛ′)=(0,0), i.e., the center midpoint of the instructor's repeat display. In FIG. 5 this vector intersects the screen plane 41 at point 43 (defined by the equation Sₓx+S_{z}z+S₀=0).
S2: the vector from the actual eyepoint through a point (xᵢₛ, yᵢₛ, zᵢₛ) where (xᵢₛ′, yᵢₛ′)=(1,0), i.e., the right edge midpoint of the instructor's repeat display (point 45 where that vector meets the plane 41 of the display screen).
S3: the vector from the actual eyepoint through a point (xᵢₛ, yᵢₛ, zᵢₛ) where (xᵢₛ′, yᵢₛ′)=(0,1) on the screen, i.e., the top edge midpoint of the instructor's repeat display (point 47 where that vector meets the plane 41 of the display screen).
8. These vectors S1, S2 and S3 are in cockpit coordinates x_{display}, y_{display}, z_{display}, and the system multiplies each of the vectors by the cockpit to construction matrix Q, i.e., rotating those vectors into the orientation of the construction coordinates, yielding construction coordinate vectors:

\vec{C}1=[Q1]\vec{S}1

\vec{C}2=[Q1]\vec{S}2

\vec{C}3=[Q1]\vec{S}3
9. The system determines the normal vectors to the plane where xᵢₛ=0 using \vec{S}1·\vec{S}3, and the plane in which yᵢₛ=0 using \vec{S}1·\vec{S}2:

\vec{N}_{X0}=\vec{S}1×\vec{S}3

\vec{N}_{YO}=\vec{S}1×\vec{S}2
10. The system then determines the elements of the final construction axis projection matrix PM per the following equation:

$$PM = [ \begin{matrix}\frac{- C {2}_{z}}{[ {\vec{N}}_{X 0} \cdot \vec{C} 2 ]} [ {\vec{N}}_{X 0}^{T} ] \\ \frac{- C {3}_{z}}{[ {\vec{N}}_{Y 0} \cdot \vec{C} 3 ]} [ {\vec{N}}_{Y 0}^{T} ] \\ \begin{matrix}0 & 0 & - 1\end{matrix}\end{matrix} ]$$

Where C2, and C3, are the z-elements of \vec{C}2 and \vec{C}3, respectively. This matrix is derived without the computational load of inverting a matrix, and the matrix has the above described elements because, applying the matrix PM in the construction axis similarly to the first method described above, the following two equations apply:

PM′₃₁C2ₓ+PM₃₂C2_{y}+PM₃₃C2_{z}=Kₓₒ[\vec{N}ₓₒ·\vec{C}2]

PM₃₁C3ₓ+PM₃₂C3_{y}+PM₃₃C3_{z}=K_{yo}[\vec{N}_{yo}·\vec{C}3]
In the construction axes, however, PM₃₁=0, PM₃₂=0, and PM₃₃−1, and therefore it follows that −CZ_{z}=Kₓₒ└\vec{N}ₓₒ·\vec{C}2┘ and −C3_{z}=K_{yo}[\vec{N}_{yo}·\vec{C}3]. Therefore:

$${K}_{x 0} = \frac{- C {2}_{z}}{[ {\vec{N}}_{x 0} \cdot \vec{C} 2 ]} and {K}_{y 0} = \frac{- C {3}_{z}}{[ {\vec{N}}_{yo} \cdot \vec{C} 3 ]}$$

and no calculation of a matrix inverse is required.

The PM matrix is then used as by the rendering system as the projection matrix converting coordinates in the construction or view frustum axes to the projection plane coordinates or instructor repeat axes (xᵢₛ, yᵢₛ,

Application to OpenGL Matrices

As is well known in the art, the OpenGL rendering software normally relies on a 4×4 OpenGL projection matrix.

For a simple perspective projection, the OpenGL matrix would take the form

$$[ \begin{matrix}\frac{2 n}{r - l} & 0 & \frac{r + l}{r - l} & 0 \\ 0 & \frac{2 n}{t - b} & \frac{t + b}{t - b} & 0 \\ 0 & 0 & \frac{- ( f + n )}{f - n} & \frac{- 2 fn}{f - n} \\ 0 & 0 & - 1 & 0\end{matrix} ]$$

in which the following terms are defined per OpenGL:

n=the near clip distance,

r, l, t and b=right, left, top and bottom clip coordinates on a plane at distance n

f=far clip distance.

The processes, described above, of obtaining data to fill the elements of a perspective distorted one-pass rendering projection matrix were directed generally to obtaining a 3×3 projection matrix. Such a matrix can be mapped to a 4×4 OpenGL matrix fairly easily.

The 3×3 projection matrix PM from the equation of step 8

$$PM = \frac{PM}{\vert [ \begin{matrix}{PM}_{31} \\ {PM}_{32} \\ {PM}_{33}\end{matrix} ] \vert}$$

contains elements PM₁₁ through PM₃₃, and is the projection matrix before scaling. This unsealed matrix of the first above-described derivation method maps to the corresponding 4×4 OpenGL matrix OG as follows, incorporating the near and far clip distances as expressed above:

$$OG = [ \begin{matrix}{PM}_{11} & {PM}_{12} & {PM}_{13} & 0 \\ {PM}_{21} & {PM}_{22} & {PM}_{23} & 0 \\ {PM}_{31} [ \frac{- ( f + n )}{f - n} ] & {PM}_{32} [ \frac{- ( f + n )}{f - n} ] & {PM}_{33} [ \frac{- ( f + n )}{f - n} ] & \frac{- 2 fn}{f - n} \\ {PM}_{31} & {PM}_{32} & {PM}_{33} & 0\end{matrix} ]$$

In the second derivation method using construction axes, the mapping is simpler. The second method yields the matrix PM according to the formula

$$PM = [ \begin{matrix}\frac{- C {2}_{z}}{[ {\vec{N}}_{X 0} \cdot \vec{C} 2 ]} [ {\vec{N}}_{X 0}^{T} ] \\ \frac{- C {3}_{z}}{[ {\vec{N}}_{Y 0} \cdot \vec{C} 3 ]} [ {\vec{N}}_{Y 0}^{T} ] \\ \begin{matrix}0 & 0 & - 1\end{matrix}\end{matrix} ]$$

PM has elements PM₁₁ through PM₃₃. For an OpenGL application, this 3×3 matrix is converted to the 4×4 Open GL matrix OG as follows, again using n and fas defined above.

$$OG = [ \begin{matrix}{PM}_{11} & {PM}_{12} & {PM}_{13} & 0 \\ {PM}_{21} & {PM}_{22} & {PM}_{23} & 0 \\ 0 & 0 & \frac{- ( f + n )}{f - n} & \frac{- 2 fn}{f - n} \\ 0 & 0 & - 1 & 0\end{matrix} ]$$

Although the projection function within the OpenGL uses all 16 elements to create an image, setting up the matrix for perspective projection requires that 9 of the 16 elements within the matrix be set to 0 and that one element be set to a value of −1. Therefore, only 6 out of the 16 elements in the 4×4 OpenGL projection matrix require computation in the usual rendering process.

Whichever of these methods is implemented in the system, subsequent operations are performed as described in the respective methods to obtain an OpenGL matrix in that can be used in the given OpenGL application to obtain a suitable matrix for single-pass rendering of the instructor station display images.

It will be understood that there may be a variety of additional methods or systems that, in real time, derive a projection matrix, either a 3×3 or a 4×4 OpenGL matrix, that transforms coordinates of the scene data to coordinates of a perspective-distorted view of the scene data rendered onto a screen from an off-axis point of view, e.g., the detected eyepoint. A primary concern is that the calculation or derivation process must constitute a series of software-directed computer processor operations that can be executed by the relevant processor rapidly enough that the projection matrix can be provided or determined in the computer rendering system and the image for the given duty cycle rendered within the duty cycle of the computer system so that the series of images that make up the instructor station display video is produced without delay or the computation time for a given frame of the video delaying the determination of the projection matrix and the rendering of the next image frame of the video.

Another issue that may develop is that the trainee may be looking at two or more screens in different planes meeting at an angulated edge, as may be the case in a polyhedral SimuSphereTM or SimuSphere HDTM simulator sold by L-3 Communications Corporation, and described in United States Patent Application of James A. Turner et al., U.S. publication number 2009/0066858 A1 published on Mar. 12, 2009, and herein incorporated by reference. In such a situation, the imagery for the perspective distorted view of each screen, or of the relevant portion of each screen, is rendered in a single pass using a respective perspective-distorted projection matrix for each of the screens involved in the trainee's actual view. the images rendered for the screens are then stitched together or otherwise merged so as to reflect the trainee's view of all relevant screens in the trainee's field of view.

It will be understood that the terms and language used in this specification should be viewed as terms of description not of limitation as those of skill in the art, with this specification before them, will be able to make changes and modifications thereto without departing from the spirit of the invention.

What is claimed is:

1. A system for providing review of a trainee being trained in simulation, said system comprising:
a computerized simulator displaying to the trainee a real-time OTW scene of a virtual world rendered from scene data stored in a computer-accessible memory defining said virtual world; and
a review system having a storage device storing or a display device displaying a view of the OTW scene from a time-variable detected viewpoint of the pilot, said view of the OTW scene being rendered from said scene data in a single rendering pass.

2. A system according to claim 1, wherein the simulator includes a screen, and the real-time OTW scene and the view of the OTW scene each comprises video made up of a respective series of real-time rendered images.

3. A system according to claim 2, wherein the screen is planar.

4. A system according to claim 3, wherein the system includes a computerized image rendering system rendering the images of the video of the view of the OTW scene, and the images are each rendered in a respective rendering cycle in a single pass by said image rendering system.

5. A system according to claim 4, wherein the scene data includes stored object data defining virtual objects to be displayed in the OTW scene, said object data including location data comprising at least one set of coordinates reflecting a location of the virtual object in the virtual world, and
wherein the computerized image rendering system renders the images of the view of the OTW scene in real time by a process that includes computerized calculation of multiplication of a perspective projection matrix performed on the sets of coordinates of the virtual objects in the OTW scene.

6. A system according to claim 5, wherein the system includes a tracking system generating a data signal corresponding to a line of sight and an eyepoint of the trainee, and said projection matrix multiplication using a perspective projection matrix derived from the line of sight and eyepoint of the trainee and stored screen definition data defining a position of the screen in the simulator, said perspective projection matrix of the matrix multiplication being configured such that the image generated for the review system is a view of the OTW scene displayed on the screen as seen by the trainee with a perspective distortion due to the detected eyepoint of the trainee.

7. A system according to claim 6, wherein the OTW scene is rendered from the scene data using an OTW projection matrix, and the perspective projection matrix is derived from the detected eyepoint and the stored screen definition data to provide for perspective of viewing of the screen from the detected eyepoint.

8. A system according to claim 7, wherein the review system has a display device displaying the scene generated by the computerized image rendering system in real time so as to be viewable by an instructor, and wherein the perspective projection matrix is derived each rendering cycle from the data signal generated in said rendering cycle.

9. A system according to claim 7, wherein the derivation of the perspective transformation matrix includes determination of at least three vectors from the eyepoint of the trainee to the screen, said vectors passing through a plane (xᵢₛ, yᵢₛ) of viewing of the review station at points at which xᵢₛ is zero and/or yᵢₛ is zero.

10. A system according to claim 9, wherein the derivation of the perspective transformation matrix includes a determination of a construction plane that passes through the design eyepoint and through a line defined by an intersection of a plane of the screen and a plane through the detected trainee eyepoint that is normal to the detected line of sight of the trainee, wherein said construction plane corresponds to a coordinate system for which an intermediate matrix is calculated, said intermediate matrix converting coordinates multiplied thereby to coordinates in said coordinate system.

11. A system according to claim 9, wherein the system further comprises a head-up display apparatus that displays HUD imagery so as to appear to the trainee superimposed over the OTW scene, and wherein said HUD imagery is superimposed on the view of the OTW scene stored or displayed by the review station.

12. A system according to claim 9, wherein the computerized image rendering system operates based on OpenGL programming, and the projection matrix is a 4×4 OpenGL projection matrix.

13. A system for providing simulation of a vehicle to a user, said system comprising:
a simulated cockpit configured to receive the user and to interact with the user so as to simulate the vehicle according to simulation software running on a simulator computer system;
a computer-accessible data storage memory device storing scene data defining a virtual simulation environment for the simulation, said scene data being modified by the simulation software so as to reflect the simulation of the vehicle, and including object data defining positions and appearance of virtual objects in a three-dimensional virtual simulation environment, said object data including for each of the virtual objects a respective set of coordinates corresponding to a location of the virtual object in the virtual simulation environment;
an OTW image generating system cyclically rendering a series of OTW view frames of an OTW video from the scene data, each OTW view frame corresponding to a respective view at a respective instant in time of virtual objects in the virtual simulation environment from a design eyepoint located in the virtual simulation environment and corresponding to a predetermined point in the simulated vehicle as said point is defined in the virtual simulation environment;
a video display device having at least one screen visible to the user when in the simulated cockpit, said OTW video being displayed on the screen so as to be viewed by the user;
a viewpoint tracker detecting a current position and orientation of the user's viewpoint and transmitting a viewpoint tracking signal containing position data and orientation data derived from said detected current position and current orientation;
a head-up display device viewed by the user such that the user can thereby see frames of HUD imagery, said HUD imagery including visible information superimposed over corresponding virtual objects in the OTW view video irrespective of movement of the eye of the user in the simulated cockpit;
a review station image generating system generating frames of review station video in a single rendering pass from the scene data, said frames each corresponding to a rendered view of virtual objects of the virtual simulation environment as seen on the display device from a rendering viewpoint derived from the position data at a respective time instant in a respective rendering duty cycle combined with the HUD imagery;
said rendering of the frames of the review station video comprising determining a location of at least some of the virtual objects of the scene data in the frame from vectors derived by calculating a multiplication of coordinates of each of said some of the virtual objects by a perspective-distorted projection matrix derived in the associated rendering duty cycle from the position and orientation data of the viewpoint tracking signal; and
a computerized instructor station system with a review display device receiving the review station video and displaying the review station video in real time on said review display device so as to be viewed by an instructor.

14. A system according to claim 13, wherein the projection matrix is derived each rendering cycle by the second image generator by a process that includes determining at least three vectors from the viewpoint defined by the position data to a plane in which the screen of the video display device lies, said vectors passing through a center midpoint of the frame being rendered, the right edge midpoint of said frame, and the top edge midpoint of said frame, respectively.

15. A system according to claim 14, wherein the derivation of the projection matrix includes derivation of an intermediate matrix transforming coordinates of virtual objects in the scene data from a cockpit coordinate system to a construction axes coordinate system in which the x-y plane passes through the design eyepoint and a line defined by an intersection of the plane of the screen with a normal plane to a line of sight of the position and orientation data.

16. A method for providing instructor review of a trainee in a simulator, said method comprising the steps of:
rendering sequential frames of an OTW view video in real time from stored simulator scene data;
displaying said OTW video to the trainee on a screen;
detecting a current position and orientation of a viewpoint of the trainee continually; and
rendering sequential frames of a review video each corresponding to a view of the trainee of the OTW view video as seen on the screen from the detected eyepoint, wherein said rendering is performed in a single rendering pass from said stored simulator scene data.

17. The method of claim 16, wherein the rendering of the OTW view video and the rendering of the review video being in real time.

18. The method of claim 16, and further comprising
generating frames of HUD imagery, and
displaying said HUD imagery to the trainee using a HUD display device, said HUD imagery including symbology relating to virtual objects defined in the scene data, said HUD imagery having said symbology therein located so the symbology associated with said virtual objects appears to the trainee superimposed on the associated virtual objects in the OTW view video irrespective of the viewpoint of the trainee; and
combining the HUD imagery with the review video so that the review video has said HUD imagery therein superimposed over said virtual objects as seen in the review video.

19. The method of claim 16, wherein the rendering of the sequential frames of the review video includes determining for each frame a respective projection matrix from coefficients defining the position of the screen in the simulator and from the respective detected viewpoint of the trainee, and multiplying coordinates of virtual objects in the scene data by said projection matrix so as to derive xᵢₛ′, yᵢₛ′ coordinates in the frame of the virtual objects.

20. The method of claim 19, wherein the projection matrix is determined by calculating vectors from the viewpoint to the screen through the xᵢₛ′, yᵢₛ′ coordinates of the screen at (0,0), (0,1), and (1,0), respectively.

21. A method of providing a simulation of an aircraft for a user in a simulated cockpit with supervision or analysis by an instructor at an instruction station with a monitor, said method comprising:
formulating scene data stored in a computer-accessible memory device than defines positions and appearances of virtual objects in a 3-D virtual environment in which the simulation takes place;
generating an out-the-window view video comprising a first sequence of frames each rendered in real time from the scene data as a respective view for a respective instant in time from a design eyepoint in the aircraft being simulated as said design eyepoint is defined in a coordinate system in the virtual environment;
displaying the out-the-window view video on a screen of a video display device associated with the simulated cockpit so as to be viewed by the user;
detecting repeatedly a time-varying position and orientation of a head or eye of the user using a tracking device in the simulated cockpit and producing viewpoint data defining said position and orientation;
generating in real time an instructor-view video comprising a second sequence of frames each rendered in a single pass from the scene data based on the viewpoint data, wherein each frame corresponds to a respective view of the out-the-window video at a respective instant in time as seen from a viewpoint as defined by the viewpoint data on the screen of the video display device; and
displaying the instructor-view video to the instructor on said monitor.
